(19) United States
(12) Patent Application Publication
(10) Pub. No.: US 2026/0309122 A1
(43) Pub. Date: Oct. 8, 2026

(54) IMPROVED PRESSURE ADAPTER FOR HYDRAULIC SYSTEM

(71) Applicant: POCLAIN HYDRAULICS INDUSTRIE, Verberie (FR)

(72) Inventors: Gilles Lemaire, Verberie (FR); Paul Fournet, Verberie (FR); Yoann Rousseau, Verberie (FR)

(73) Assignee: POCLAIN HYDRAULICS INDUSTRIE, Verberie (FR)

(21) Appl. No.: 19/482,544

(22) PCT Filed: May 6, 2024
(86) PCT No.: PCT/FR2024/050596

§ 371 Date: Nov. 7, 2025

(30) Foreign Application Priority Data
May 10, 2023 (FR) FR2304631

(51) Int. Cl. F03C 1/24; F04B 1/0413; F04B 1/043; F04B 1/1071; F04B 5/00

(52) U.S. Cl. CPC F03C 1/2407; F04B 1/0413; F04B 1/043; F04B 1/1071; F04B 5/00

(57) ABSTRACT

A pressure adapter having a first assembly and a second assembly, movable in rotation relative to each other along a main axis, the first assembly has a casing and a cam, the second assembly has a cylinder block with a plurality of housings in which pistons slide. Each piston is positioned in a housing. Each pair formed by a piston and a housing defines between the piston and the housing a first chamber and a second chamber distinct from each other. The first chamber and the second chamber define distinct displacements, in which the assembly of the first chambers performs a hydraulic motor function, adapted to be connected to a supply providing a first flow rate Q1 at a first pressure P1 and to perform a relative rotation of the first assembly and the second assembly, the assembly of the second chambers performs a hydraulic pump function, adapted to deliver a second flow rate Q2 at a second pressure P2.

### TECHNICAL FIELD

The present invention relates to a pressure adapter for a hydraulic system, which can in particular fulfill a pressure amplifying function.

### PRIOR ART

The hydraulic systems are commonly used in many applications. In such systems, a recurring desire is to reduce the space requirement for obvious reasons of reduction of the mass and volume of the assembly, and also to facilitate the integration thereof.

In the case of hydraulic machines, it is thus known to seek to adapt the pressure and the flow rate of a hydraulic member in order to optimize the system. In particular, it is known to use a pressure amplifier rather than overdimension the hydraulic components, which not only allows the use of the standardized elements for different applications, but also reduces their space requirement.

The known pressure adapters generally have a linear oscillating structure and are complex to make. The present invention thus aims to address at least partially these various issues.

### DISCLOSURE OF THE INVENTION

The present invention thus relates to a pressure adapter comprising:
a first assembly and a second assembly, movable in rotation relative to each other along a main axis,
the first assembly comprising a cam,
the second assembly comprising a cylinder block with a plurality of housings in which pistons slide, each piston being positioned in a housing,
characterized in that:
each pair formed by a piston and a housing defines between the piston and the housing a first chamber and a second chamber distinct from each other, the first chamber and the second chamber defining distinct displacements,
in which
the assembly of the first chambers performs a hydraulic motor function, adapted to be connected to a supply providing a first flow rate Q1 at a first pressure P1 and to perform relative rotation of the first assembly and the second assembly, the assembly of the second chambers performs a hydraulic pump function, adapted to deliver a second flow rate Q2 at a second pressure P2. Such a pressure adapter has the advantage, compared to the prior art and in particular to the linear oscillating adapters, of being compact and of being able to significantly amplify the pressure while allowing the provision of a significant flow rate. Furthermore, the proposed structure allows making a constant velocity adapter, and therefore providing a constant flow rate and not a flow rate by jerks or pulsations.

According to one example, the pressure adapter comprises a casing, the first assembly being secured to the casing.

According to one example, the pressure adapter comprises a casing, the second assembly being secured to the casing.

According to one example, for each pair formed by a piston and a housing, the first chamber defines a displacement strictly greater than the second chamber.

According to one example, for each pair formed by a piston and a housing, the first chamber defines a displacement strictly smaller than the second chamber.

According to one example, for each pair formed by a piston and a housing, the first chamber and the second chamber are superimposed along a sliding direction of the piston in the housing.

According to one example, each housing has a first portion with a first section S1, and a second portion with a second section S2, the first section S1 being strictly greater than the second section S2, the first portion opening out from an outer surface of the cylinder block facing the cam, and the second portion extending from the first portion.

According to one example, the assembly of the first chambers performing a hydraulic motor function has a primary intake and a primary discharge, the assembly of the second chambers performing a hydraulic pump function has a secondary intake and a secondary discharge, the primary discharge supplies at least part of the secondary intake.

According to one example, the connection between the primary discharge and the secondary intake is made via an internal volume of the casing.

According to one example, the assembly of the first chambers performing a hydraulic motor function has a primary intake and a primary discharge, the assembly of the second chambers performing a hydraulic pump function has a secondary intake and a secondary discharge, the secondary intake and the primary intake are common.

According to one example, the first chambers are connected to a first distributor adapted to perform fluid intake and discharge, and the second chambers are connected to a second distributor adapted to perform fluid intake and discharge.

According to one example, the cylinder block comprises ducts adapted to connect the first chambers to the first distributor, said ducts opening out from the cylinder block at a first distance R1 relative to the main axis, and the cylinder block comprises ducts adapted to connect the second chambers to the second distributor, said ducts opening out from the cylinder block at a second distance R2 relative to the main axis, the first distance R1 and the second distance R2 being distinct from each other.

According to one example,
if Q1>Q2, then R1>R2, and
if Q1<Q2, then R2>R1.

According to one example, the pistons and the housings are disposed so as to define a motion of the pistons along a direction parallel to the main axis.

According to one example, the pistons and the housings are disposed so as to define a motion of the pistons along a radial direction relative to the main axis.

According to one example, the pressure adapter may be a multi-lobe cam adapter.

According to one example, the assembly of the first chambers defines a first hydraulic sub-machine that operates by the collaboration of the pistons sliding in these first chambers with a multi-lobe cam.

According to one example, the assembly of the second chambers defines a second hydraulic sub-machine that operates by the collaboration of the pistons sliding in these second chambers with a multi-lobe cam.

According to one example, the assembly of the first chambers defines a first hydraulic sub-machine that operates by the collaboration of the pistons sliding in these first chambers with a multi-lobe cam configured such that the hydraulic sub-machine is a constant velocity hydraulic sub-machine. A hydraulic machine or sub-machine is a constant velocity hydraulic machine or sub-machine if, at constant rotation (of the cylinder block), the flow rate circulating in the sub-machine is constant. In other words, the rotation occurs smoothly. In a constant velocity machine, the fluid balance is substantially zero, that is to say at any moment, the amount of fluid entering the cylinders is substantially equal to the amount of fluid leaving the cylinders.

To the extent that a constant flow rate circulates in the various ducts for a constant rotational speed of the hydraulic machine, there is no acceleration or deceleration of the fluid in the ducts, which allows in particular reducing the pressure drops and therefore increasing the efficiency of the machine.

According to one example, the assembly of the second chambers defines a second hydraulic sub-machine that operates by the collaboration of the pistons sliding in these second chambers with a multi-lobe cam configured such that said second hydraulic sub-machine is a constant velocity hydraulic sub-machine.

According to one example, the assembly of the first chambers defines a first hydraulic sub-machine that operates by the collaboration of the pistons sliding in these first chambers with a multi-lobe cam configured such that said first hydraulic sub-machine is homogeneous. The term homogeneous means that at constant rotation (of the cylinder block) for each cam lobe, the flow rate circulating in the first chambers whose pistons travel through the cam lobe in question is constant. One example of a hydraulic machine with homogeneous flow rate is presented in the patent application WO2023/242502A1 to which those person skilled in the art may refer.

When the hydraulic machine (or sub-machine) associates a particular distribution means for a lobe or a group of lobes of the multi-lobe cam, the fact that the hydraulic machine (or sub-machine) is homogeneous allows a constant flow rate to circulate in the ducts of this distribution means assigned to this lobe or group of lobes for a constant rotational speed of the hydraulic machine (or sub-machine).

To the extent that a constant flow rate circulates in the various ducts of the distribution system dedicated to a lobe or group of lobes for a constant rotational speed of the hydraulic machine, there is no acceleration or deceleration of the fluid in the ducts of the distribution system dedicated to this lobe or group of lobes, which in particular allows reducing the pressure drops and therefore increasing the efficiency of the hydraulic machine or sub-machine.

According to one example, the assembly of the second chambers defines a second hydraulic sub-machine that operates by the collaboration of the pistons sliding in these second chambers with a multi-lobe cam configured such that said second hydraulic sub-machine is homogeneous.

According to one example, the cam profile is non-sinusoidal. The non-sinusoidal cam in particular allows profiles that allow for a constant velocity or homogeneous hydraulic machine (or sub-machine).

According to one example, the cam profile has in particular cam flats. What those skilled in the art call “cam flat” is part of the cam for which, for a given angular sector of the cam, the radius of the cam profile does not change. Consequently, a piston traveling through a cam flat does not move in its housing and does not generate a flow rate. This allows in particular preventing pressure peaks in the chamber from being created during the passage from one distribution hole to the other. This allows in particular spacing apart the distribution holes from each other to improve the sealing by preventing leaks from high-pressure ducts to low-pressure ducts at the level of the distribution face.

According to one example, the pressure adapter may be a radially external cam adapter, the cam then being arranged radially outward relative to the cylinder block.

According to one example, the first distributor and the second distributor are disposed on either side of the cylinder block along the direction defined by the main axis.

According to one example, the first distributor and the second distributor are dimensioned such that the force resulting from the supply of the first chambers and the second chambers respectively by the first distributor and the second distributor tends to move the cylinder block towards one among the first distributor and the second distributor, typically either towards the first distributor or towards the second distributor, typically by minimizing the force resulting from the supply of the first chambers and the second chambers respectively by the first distributor and the second distributor. As a variant, the first distributor and the second distributor are dimensioned such that the force resulting from the supply of the first chambers and the second chambers respectively by the first distributor and the second distributor tends to balance each other.

According to one example, the pressure adapter may have a radially external and rotating cam and a fixed cylinder block secured in rotation to the casing.

According to one example, the pressure adapter may be of radial technology with an internal multi-lobe cam.

According to one example, the pressure adapter may be of radial technology with a fixed casing and rotating internal multi-lobe cam. In this case the casing and the cylinder block may be rigidly connected.

The adapter as proposed can in particular be integrated into a hydraulic machine, for example into a hydraulic motor or into a hydraulic jack.

### BRIEF DESCRIPTION OF THE DRAWINGS

The invention and its advantages will be better understood upon reading the following detailed description of various embodiments of the invention given as non-limiting examples.

FIG. 1 is a schematic representation of a pressure adapter.

FIG. 2 is a schematic representation of a pressure adapter according to one exemplary embodiment.

FIG. 3 is a schematic representation of a pressure adapter according to another exemplary embodiment.

FIG. 4 is a schematic representation of another exemplary pressure adapter according to another exemplary embodiment.

FIG. 5 is a schematic representation of a pressure adapter according to another exemplary embodiment.

FIG. 6 is a schematic representation of the variant represented in FIG. 5, but in a different configuration.

FIG. 7 is a schematic representation of another variant of a pressure adapter according to one exemplary embodiment.

FIG. 8 is a view of one exemplary distributor for a pressure adapter according to one exemplary embodiment.

FIG. 9 is a schematic representation of another variant of a pressure adapter according to another exemplary embodiment.

FIG. 10 is a schematic representation of another variant of a pressure adapter according to another exemplary embodiment.

FIG. 11 is a view of one exemplary pressure adapter according to another exemplary embodiment.

FIG. 12 is a schematic representation of a hydraulic member integrating an adapter according to one aspect of the invention.

Throughout the figures, the elements in common are identified by identical reference numerals.

### DESCRIPTION OF THE EMBODIMENTS

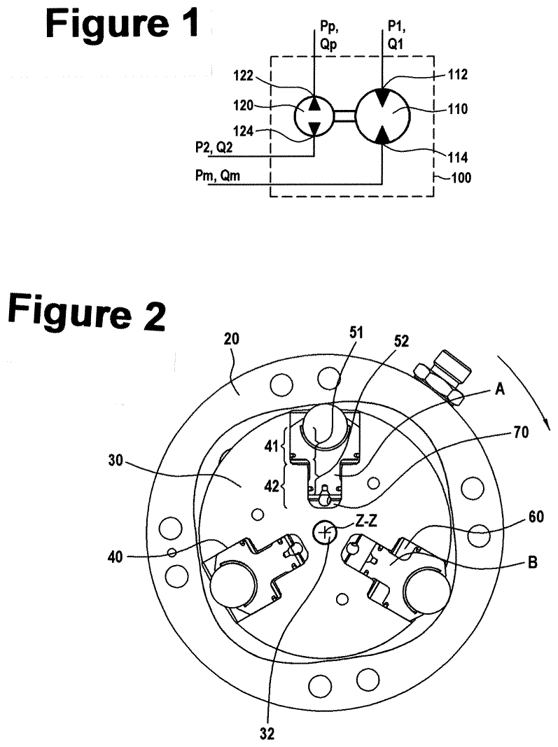

FIG. 1 is a schematic representation of a pressure adapter 100.

The pressure adapter 100 as shown schematically has two hydraulic members coupled in rotation, one being adapted to operate as a motor, and the other being adapted to operate as a pump. The hydraulic motor will be designated here by the reference 110, and the hydraulic pump will be designated by the reference 120.

The hydraulic motor 110 has a primary intake 112 and a primary discharge 114. The hydraulic pump 120 has a secondary intake 122 and a secondary discharge 124. The hydraulic motor 110 is adapted to be connected to a supply providing a first flow rate Q1 at a first pressure P1, and discharges a flow rate Qm (in the embodiments presented, Qm=Q1 if there are no leaks) at a pressure Pm. The hydraulic motor 110 performs a rotation of the hydraulic pump 120. The hydraulic pump 120 is supplied by a flow rate Qp (in the embodiments presented Qp=Q2 if there are no leaks) at a pressure Pp, and is adapted to deliver a second flow rate Q2 at a second pressure P2 such that P2 is different from P1. It is known to those skilled in the art that for an operation of the pump without cavitation, the pressure Pp at the intake of the pump must be greater than a minimum boost pressure of the pump.

Depending on the desired pressure adaptation, P2 may be greater than P1 or less than P1, thus respectively raising or lowering the pressure.

Such an adapter 100 comprises one or more hydraulic machines each comprising a first assembly and a second assembly, movable in rotation relative to each other along a main axis Z-Z visible in particular in FIG. 2.

The first assembly comprises a cam. The cam is typically a multi-lobe cam. A multi-lobe cam is a cam formed so as to have undulations or lobes, so that a piston in a cylinder block housing shown centered relative to the cam and remaining in contact with the cam performs reciprocating motions in its housing during rotation.

The cam is typically non-sinusoidal. A non-sinusoidal profile of the cam allows in particular making a cam profile that allows making a constant velocity or homogeneous hydraulic machine (or sub-machine).

The second assembly comprises a cylinder block having a plurality of housings in which pistons slide, each piston being positioned in a housing. The adapter 100 is configured such that, during operation, the pistons follow the cam. Thus, the pistons perform reciprocating motions in their respective housings depending on the geometry of the cam, while remaining in contact with the cam.

Depending on the architecture chosen, a casing may be secured in rotation to the first assembly or the second assembly.

The hydraulic motor 110 drives in rotation the hydraulic pump 120. However, the adapter does not have the function of delivering a torque. Thus, the adapter 100 typically does not have a mechanical torque input or output shaft. In other words, the adapter 100 does not have a torque input or output. A pressure and a flow rate are applied as input, and a pressure and a flow rate are delivered as output.

FIG. 2 shows a schematic view of components for making a pressure adapter according to one aspect of the invention.

In this example, the pressure adapter 100 according to the invention has a radial structure. By radial structure, it is meant that the pistons 50 and the housings 40 are disposed so as to define a motion of the pistons 50 along a radial direction relative to the main axis Z-Z. The pressure adapter 100 then has a structure described as radial.

This figure represents a cam 20 and a casing 10. The cam is positioned so as to surround the cylinder block 30 relative to the main axis Z-Z. The casing 10 and the cam 20 define an internal volume in which the cylinder block 30 is housed, which is movably mounted in rotation relative to the assembly formed by the cam 20 and the casing 10, typically by means of an axis 32 defining the main axis Z-Z. The axis 32 is optional. The cylinder block 30 can typically be positioned in the casing 10 without an axis 32. Bearing elements then allow typically centering the cylinder block 30 relative to the cam 20.

In the example illustrated, the cam 20 has 4 lobes, and the cylinder block 30 has 3 housings 40, each housing being provided with a piston 50. The cam 20 thus has a plurality of lobes, so that during the rotation of the cylinder block 30, a piston 50 held in contact with the cam 20 will perform reciprocating motions in its housing due to the lobes of the cam 20, the maximum amplitude of the movement of the piston 50 in its housing 40 defining the stroke of the piston 50.

In the structure proposed by the present invention, each pair formed by a piston and a housing defines a first chamber 60 and a second chamber 70 that are distinct, isolated from each other by means of sealing elements, and defining distinct displacements. The displacement is defined as the product of the effective section of a chamber considered by the piston stroke, the effective section of a piston being the total surface of the piston that contributes to creating a force tending to move the piston in the desired direction. A distinction is made between the displacement for a given piston and the displacement for a motor or a pump, which is equal to the sum of the displacement of the pistons for the motor or the pump considered.

Such a structure allows defining in a single cylinder block a hydraulic pump and a hydraulic motor with distinct displacements, one of the chambers 60 or 70 thus defining the hydraulic pump, and the other of the chambers 60 and 70 defining the hydraulic motor. In the remainder of the text, the term hydraulic motor will refer to the assembly of the chambers performing a hydraulic motor function, and the term hydraulic pump will refer to the assembly of the chambers performing a hydraulic pump function.

The first chamber 60 and the second chamber 70 are typically superimposed along the sliding direction of the piston 50 in the housing 40.

In the example illustrated, the housing 40 has two distinct portions; a first portion 41 having a first section S1, and a second portion 42 having a second section S2, the first section S1 being strictly greater than the second section S2, the first portion extending from an outer surface of the cylinder block 30 and opening out facing the cam, and the second portion 42 extending from the first portion 41 so as to form the bottom of the housing 40. The second portion 42 is thus typically blind along the sliding direction of the pistons 50.

The piston 50 also has a first portion 51 and a second portion 52 adapted to slide respectively in the first portion 41 and the second portion 42 of the housing 40 while ensuring the sealing of the first chamber 60 and the second chamber 70.

In the example illustrated, ducts are arranged in the cylinder block 30, these ducts extending from the first chambers 60 and from the second chambers 70 and opening out from a lateral surface of the cylinder block 30. The ducts are then supplied by distributors.

One example of operation is presented below.

In this example, it is considered that the first chambers 60 perform a hydraulic motor function adapted to perform a rotation of the cylinder block 30 and form the hydraulic motor of displacement C1=N*S1*CO with CO designating the stroke of the piston 50 and N the number of pistons (N=3 in the illustrated example), and that the second chambers 70 perform a hydraulic pump function and form the hydraulic pump of displacement C2=N*S2*CO so as to deliver a flow rate and a pressure. It is noted here that the stroke CO is the same for the first chambers 60 and second chambers 70. It is understood that this example is only limiting, and that an inverse configuration is also possible, in which the first chambers 60 perform a hydraulic motor function adapted to perform a rotation of the cylinder block 30, and the second chambers 70 perform a hydraulic pump function.

If two pistons represented in FIG. 2 are considered, two pistons are designated by the letters A and B, and a clockwise direction of rotation of the cylinder block 30 indicated by an arrow is considered. Considering the direction of rotation indicated, the piston A is in the phase of exit from its housing, while the piston B is in the phase of withdrawal in the housing. The first chamber 60 is supplied by a flow rate Q1 at a pressure P1 described as high pressure and which generates a force tending to exit the piston from its housing to cause the relative rotation of the cylinder block relative to the cam. The second chamber 70 is supplied at a supply pressure Pp described as low pressure.

The piston B is in the discharge phase. The first chamber 60 discharges a flow rate Qm (in this particular example Qm=Q1) at a pressure Pm described as low pressure, such that Pm<P1, and the second chamber 70 delivers a flow rate Q2 at a pressure P2 such that P2>Pp.

The pressure adapter 100 is typically a constant velocity adapter; for a constant rotational speed of the cylinder block 30 relative to the cam 20, it delivers a constant or substantially constant flow rate, in contrast in particular to a linear oscillating actuator which delivers a pressure in pulsations.

The assembly of the first chambers 60 typically defines a first hydraulic sub-machine that operates by the collaboration of the pistons 50 sliding in these first chambers 60 with the multi-lobe cam 20 configured such that said first hydraulic sub-machine is homogeneous. The term homogeneous means that at constant rotation (of the cylinder block) for each cam lobe 20, the flow rate circulating in the first chambers 60 whose pistons 50 travel through the cam lobe 20 in question is constant. One example of a hydraulic machine with homogeneous flow rate is presented in patent application WO2023/242502A1 to which those skilled in the art may refer.

When the hydraulic machine (or sub-machine) associates a particular distribution means for a lobe or a group of lobes of the multi-lobe cam 20, the fact that the hydraulic machine (or sub-machine) is homogeneous allows a constant flow rate to circulate in the ducts of this distribution means assigned to this lobe or group of lobes for a constant rotational speed of the hydraulic machine (or sub-machine).

To the extent that a constant flow rate circulates in the various ducts of the distribution system dedicated to a lobe or a group of lobes for a constant rotational speed of the hydraulic machine, there is no acceleration or deceleration of the fluid in the ducts of the distribution system dedicated to this lobe or group of lobes, which in particular allows reducing the pressure drops and therefore increasing the efficiency of the hydraulic machine or sub-machine.

According to one example, the assembly of the second chambers 70 defines a second hydraulic sub-machine that operates by the collaboration of the pistons 50 sliding in these second chambers 70 with a multi-lobe cam configured such that said second hydraulic sub-machine is homogeneous.

The effect of the pressure adapter 100 will then depend in particular on the ratio between the displacements C1 and C2, and on the ratio between the intake pressures and flow rates of the first chamber 60 and the second chamber 70. Depending on the configuration of the adapter 100, the latter may in particular perform a pressure-raising or pressure-lowering function.

To the extent that the applied torque is constant between the motor and the pump due to the cylinder block 30 alone which ensures the mechanical torque connection between the motor and the pump, we have the relation (Pm−P1)*C1=(P2−Pp)*C2. The ratio between P1 and P2 thus depends in particular on the ratio between C1 and C2.

According to a first example, if it is considered that C1>C2, and that Pp=Pm (with Pp or Pm<P1), then the second chamber 70 delivers a pressure P2 such that P2>P1, due to the ratio of the displacements C1 and C2. The adapter 100 then performs a pressure amplifying function.

Conversely, if it is considered that C1<C2, and that Pp=Pm (with Pp or Pm<P1) then the second chamber 70 delivers a pressure P2 at a flow rate Q2 such that P2<P1 and such that Q2>Q1, due to the ratio of the displacements C1 and C2. The adapter 100 then performs a pressure-lowering and flow rate amplifying function.

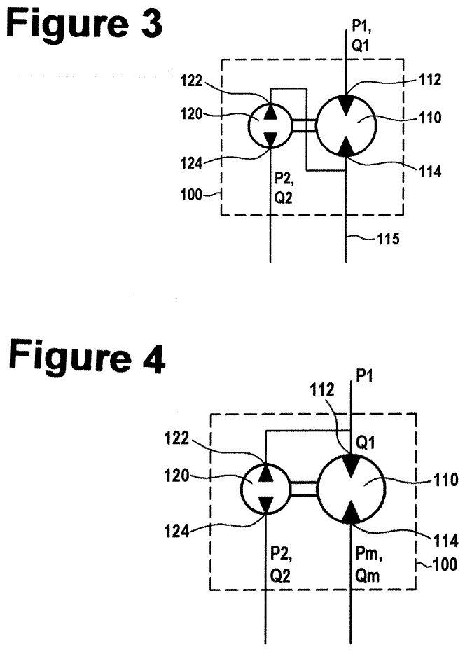

According to one example, in particular in the case where C1>C2, the intake of the hydraulic pump 120 can be connected to the discharge of the hydraulic motor 110. The discharge of the hydraulic motor 110 thus at least partly supplies the intake of the hydraulic pump 120. FIG. 3 shows a hydraulic diagram equivalent to such a mounting.

Thus, the pressure at the intake of the hydraulic pump 120 is equal to the pressure at the discharge of the hydraulic motor 110.

A line 115 typically extends from the internal volume of the casing 10 to perform the boosting of the pump 120, so that the pressure Pp at the intake 122 of the pump 120 is greater than a minimum boost pressure required for the pump 120. As a variant, the boosting is not necessary, but the system comprises means for ensuring that the pressure at the intake 122 of the pump 120 is greater than the minimum pump boost pressure, for example a restriction made on a drain of the internal volume of the casing 10 which returns to the reservoir.

As a variant, in particular in the case where C1>C2, the intake of the hydraulic pump 120 and the intake of the hydraulic motor 110 are common. Thus, the hydraulic pump 120 is supplied at a pressure P1. FIG. 4 shows a hydraulic diagram equivalent to such a mounting.

The proposed structure thus allows forming a pressure adapter by means of a hydraulic machine with a single cylinder block and a single row of pistons positioned facing the same cam, 3 pistons being sufficient, by doubling the function of each pair formed by a piston and the associated housing. One of the chambers then performs a hydraulic motor function and ensures the rotational drive, while the other chamber performs a hydraulic pump function 120 to deliver a pressure P2 modulated relative to the intake pressure P1 of the hydraulic motor 110. Such a structure therefore differs from a structure in which the cylinder block comprises several rows of pistons axially offset along the main axis Z-Z, and which can be in contact with distinct cams. The proposed structure is in particular advantageous in terms of compactness compared to such structures.

The pressure adapter 100 as proposed may in particular be integrated into a hydraulic machine, for example a hydraulic motor, or into a hydraulic member such as a jack.

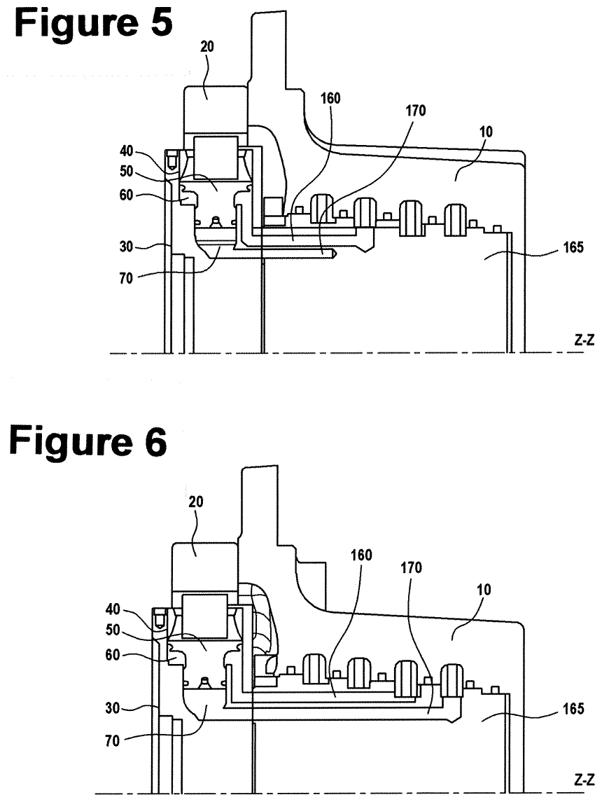

FIGS. 5 and 6 show two views of one exemplary embodiment of a pressure adapter 100 according to the invention having a radial structure. In this distribution mode, the cam 20 is typically secured in rotation to the casing 10.

The adapter 100 comprises a distribution block 165 defining a first distributor 160 and a second distributor 170. The first distributor 160 is adapted to perform fluid intake and discharge in the first chambers 60. The second distributor 170 is adapted to perform fluid intake and discharge in the second chambers 70.

The distribution block 165 is typically a grooved distributor. The distribution block 165 is interposed between the cylinder block 30 and the casing 10, and comprises distribution orifices adapted to put in communication supply and discharge ducts formed in a distribution cover here forming part of the casing 10, and ducts formed in the cylinder block 30. The distribution block 165 may for example take the form of a cylinder along the axis Z-Z, provided with four grooves on its outer periphery and allows the passage of fluid from these grooves to the distribution interface of the cylinder block via ducts made from the material of the distribution block.

The first distributor 160 and the second distributor 170 are arranged so as to have distribution ducts superimposed along the radial direction relative to the main axis Z-Z. In other words, the ducts formed in the cylinder block 30 open out at distinct positions relative to the main axis Z-Z; for example, the ducts connected to the first distributor 160 are centered on a circle of radius R1 relative to the main axis Z-Z, and the ducts connected to the second distributor 170 are centered on a circle of radius R2 relative to the main axis Z-Z with R1 different from R2.

FIG. 5 corresponds to the configuration described previously with reference to FIG. 2 and to the piston A. The piston is in the output and therefore suction phase. The first chamber 60 is supplied with a high pressure P1 at a flow rate Q1. The second chamber 70 is supplied with low pressure Pp at a flow rate Qp.

FIG. 6 corresponds to the configuration described previously with reference to FIG. 2 and to the piston B. The piston is in the withdrawal and therefore discharge phase. The first chamber 60 discharges a low pressure Pm at a flow rate Qm. The second chamber 70 delivers a flow rate Q2 at a pressure P2 such that P2>Pp.

Advantageously, the first distributor 160 and the second distributor 170 are configured so that the supply of the chamber performing the motor function is carried out in ducts radially outward relative to the ducts supplying the chamber performing the pump function. Indeed, for a given angular sector, the inner section of the ducts increases with the radius relative to the main axis Z-Z. The proposed configuration thus aims to limit the forces of the fluid on the parts by conveying the highest pressure (that is to say the pump discharge pressure in the case where the adapter 100 performs a pressure-raising function) in the radially inward ducts, and therefore of smaller section. This same configuration also allows conveying the highest flow rate, that is to say the flow rate of the motor in the case where the adapter 100 performs a pressure-raising function, in the radially outward ducts and therefore of larger section, thus limiting the pressure drops. In the case where the adapter 100 performs a pressure-lowering function, the reverse configuration is then typically made.

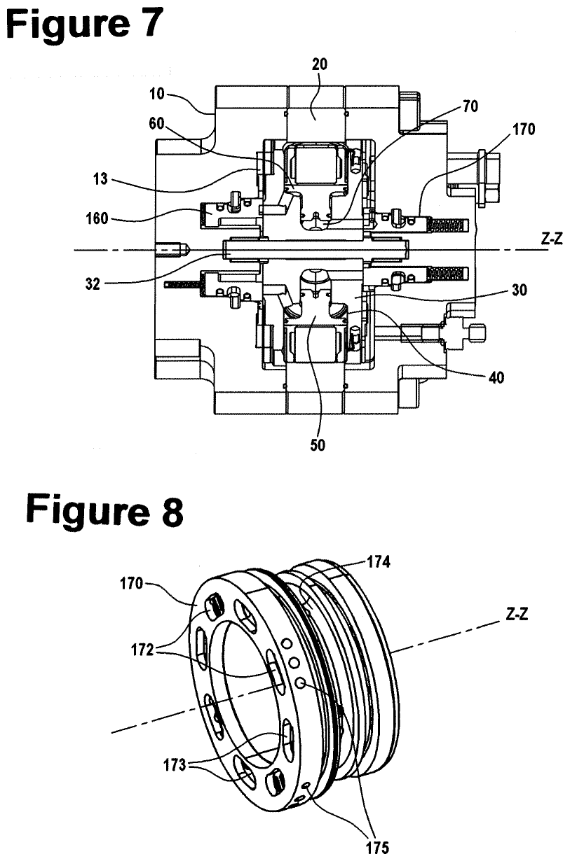

FIG. 7 shows another exemplary embodiment of a pressure adapter 100 according to the invention having a radial structure. This embodiment may for example have a structure as already described with reference to FIG. 2.

This embodiment includes the various elements already described with reference to the preceding figures. Only the differences are indicated below.

In the proposed structure, the first distributor 160 and the second distributor 170 are disposed on either side of the cylinder block 30 along the direction defined by the main axis Z-Z.

The cylinder block 30 thus comprises ducts opening out facing each of the first distributor 160 and the second distributor 170, making it possible to connect the first chambers 60 and the second chambers 70 respectively to the first distributor 160 and the second distributor 170. The ducts typically open out at an interface between the cylinder block 30 and the first distributor 160 or the second distributor 170, the interface being typically between two surfaces extending radially relative to the main axis Z-Z.

Such a structure with a distributor on either side of the cylinder block 30 is advantageous insofar as it allows balancing the forces applied to the distributor, and therefore reducing the load on the rolling elements relative to a structure comprising a single distributor on one side of the cylinder block 30. Thus, by balancing the forces applied on either side of the cylinder block 30, the load applied to the rolling elements is minimized.

As indicated previously, the first distributor 160 and the second distributor 170 are typically configured so that the supply of the chamber performing the motor function is carried out in ducts radially outward relative to the ducts supplying the chamber performing the pump function.

Optionally, the first distributor 160 and the second distributor 170 are configured so that in operation, the force resulting from the pressure supply and discharge of the first chambers 60 and the second chambers 70 tends to move the cylinder block towards one among the first distributor 160 and the second distributor 170, for example towards the first distributor 160, or alternatively towards the second distributor 170.

Such a configuration thus allows determining in advance where to position the rolling element that will have to support an axial load due to the thrust of the cylinder block 30 on one of the distributors, and thus allows dimensioning the rolling elements appropriately. A thrust bearing 13 of the needle thrust bearing, roller thrust bearing type or a shoulder may in particular be integrated into the adapter 100 in order to withstand the axial forces of the cylinder block relative to the casing 10. As a variant, such a thrust bearing may be provided on each side of the cylinder block (on either side of the cylinder block relative to the axis of rotation).

The first distributor 160 and the second distributor 170 are typically positioned facing the cylinder block 30 at distinct radial positions relative to the main axis Z-Z. The ducts formed in the cylinder block 30 and allowing them to be selectively connected to the first chambers 60 or the second chambers 70 therefore also open out at distinct radial positions relative to the main axis Z-Z. As indicated previously, the first distributor 160 and the second distributor 170 are advantageously configured so that the supply of the chamber performing the motor function is carried out in ducts radially outward relative to the ducts supplying the chamber performing the pump function.

Such a structure allows in particular simplifying the inner structure of the cylinder block 30 by increasing the spacing between the different ducts, and therefore by making it possible to improve the mechanical strength of the cylinder block 30.

FIG. 8 shows one exemplary embodiment of the second distributor 170. It is understood that the first distributor 160 may also have a similar structure.

The second distributor 170 as illustrated has a generally annular shape with a central recess. Ducts 172 and 173 are formed from an axial end of the body of the second distributor 170, these ducts being adapted to supply the second chambers 70. Annular grooves 174 are formed in the outer radial surface of the body of the second distributor 170, these annular grooves 174 being adapted to perform a fluid communication with grooves arranged in a distribution cover.

In the structure represented, the ducts 173 are formed so as to be connected to the groove 174. The ducts 172 are however isolated from the groove 174, and are connected to bores 175 opening out onto an outer radial surface of the body of the second distributor 170. The bores 175 are formed so as to open out into an internal volume of the casing 10. Thus, the second distributor 170 as proposed allows for example performing an intake of fluid collected from the internal volume of the casing 10 via the bores 175 and the ducts 172, then a discharge of fluid via the ducts 173 and the groove 174. By proposing a first distributor 160 with a similar structure, which allows performing a collection of fluid via an intake groove and a discharge in the casing 10 by means of bores equivalent to the bores 175, it is thus possible for example to make an adapter 100 with an equivalent hydraulic diagram as shown in FIG. 3, in which the connection between the discharge of the hydraulic motor 110 and the intake of the hydraulic pump 120 is made via the internal volume of the casing 10.

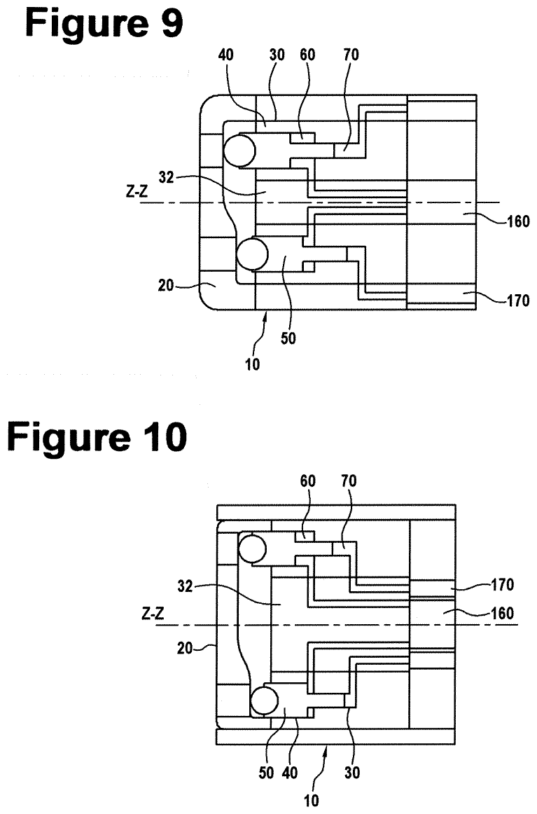

FIG. 9 is a schematic view of another embodiment.

In this embodiment, the pistons 50 and the housings 40 are disposed so as to define a motion of the pistons 50 in the housings 40 along a direction parallel to the main axis Z-Z. The pressure adapter 100 then has a structure described as axial.

This embodiment includes the various elements already described with reference to the preceding figures. The cam 20 is here positioned facing the housings 40 in which the pistons 50 slide. The cam 20 is typically a multi-lobe cam.

As a variant, the cam 20 may be formed by a plate inclined relative to the main axis Z-Z.

This figure schematically represents the first distributor 160 adapted to supply and discharge the first chambers 60, and the second distributor 170 adapted to supply and discharge the first chambers 70.

In the illustrated embodiment, the first distributor 160 is formed at least partially in the axis 32. In other words, the first distributor 160 is formed at least partially in a volume radially inside the cylinder block 30. Indeed, insofar as the adapter 100 does not have a torque transmission shaft, a volume in the center of the cylinder block 30 or where appropriate the axis 32 can be used to at least partially perform a distributor function. The cylinder block 30 thus comprises ducts extending from the first chambers 60 and opening out at the interface between the cylinder block 30 and the axis 32. These ducts extend in the axis 32 to the first distributor 160.

The second distributor 170 as represented is formed in the casing 10. The cylinder block 30 thus comprises ducts extending from the second chambers 70 and opening out at the interface between the cylinder block 30 and the casing 10. These ducts extend into the casing 10 to the second distributor 170.

In this configuration, the second distributor 170 is thus positioned around the first distributor 160. Such a configuration allows exploiting the axis 32 for the formation of the fluid circulation ducts, and is thus advantageous in that it facilitates the formation of the various ducts.

FIG. 10 is a schematic view of one variant of FIG. 9.

In this embodiment, the first distributor 160 and the second distributor 170 are formed at least partially in the axis 32 or in the extension of the axis 32.

In other words, the first distributor 160 and the second distributor 170 are formed at least partially in a volume radially inside the cylinder block 30. The cylinder block 30 thus comprises ducts extending from the first chambers 60 and opening out at the interface between the cylinder block 30 and the axis 32, and ducts extending from the second chambers 70 and opening out at the interface between the cylinder block 30 and the axis 32. These ducts extend in the axis 32 respectively to the first distributor 160 and the second distributor 170.

In the example illustrated, the ducts formed in the axis 32 open out onto the cylinder block at distinct axial positions relative to the main axis Z-Z.

Such a configuration thus allows exploiting the axis 32 for the formation of distribution ducts, and thus minimizing the space requirement of the adapter 100.

FIG. 11 is a sectional view of one particular embodiment of the pressure adapter 100 in one variant having a radial architecture with an internal cam movably mounted in rotation relative to the cylinder block 30 and the casing 10. The cylinder block 30 is then typically secured in rotation to the casing 10.

In the example illustrated in FIG. 11, the cam 20 has 4 lobes, and the cylinder block 30 has 3 housings 40, each housing being provided with a piston 50. The cam 20 thus has a plurality of lobes, such that during the rotation thereof, a piston 50 held in contact with the cam 20 will perform reciprocating motions in its housing due to the lobes of the cam 20, the maximum amplitude of the movement of the piston 50 in its housing 40 defining the stroke of the piston 50.

As for the embodiments described above, each pair formed by a piston 50 and a housing 40 defines a first chamber 60 and a second chamber 70 that are distinct, isolated from each other by means of sealing elements, and defining distinct displacements.

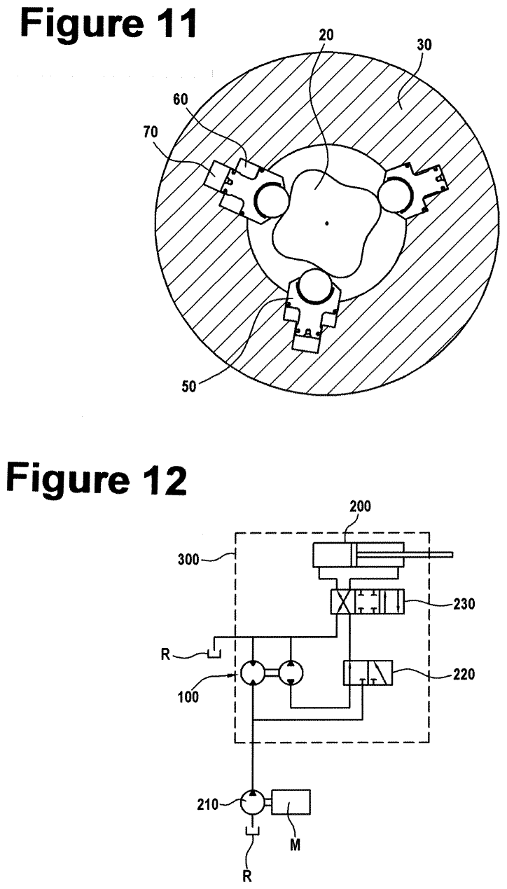

FIG. 12 is a hydraulic diagram illustrating one example of integration of the adapter 100 for a hydraulic member such as a jack.

This figure schematizes a jack 200 supplied by a pressure source, here a hydraulic pump 210 collecting a fluid from a reservoir R, and driven by a primary motor M, typically an electric or thermal motor. The hydraulic pump 210 is connected in parallel to the adapter 100 and to a pilot valve 220. The jack 200 has two chambers, connected to a selector 230. The pilot valve 220 is connected to the discharge of the adapter 100 and to the selector 230. The selector 230 allows piloting the direction of movement of the jack 200, by connecting one of the chambers to a pressure source, and the other to the reservoir R. The pilot valve 220 allows connecting the selector 230 and therefore supplying a chamber of the jack 200 via the selector 230 either directly with the hydraulic pump 210, or via the adapter 100. The proposed structure thus allows actuating the jack 200 with or without the adapter 100, in both directions of actuation.

This integration of the pressure adapter according to the invention in a structure 300 common to the jack allows in particular limiting the very high pressure in a closed physical environment (which is the structure, for example, metallic structure, of the jack) making it possible to locate the very high pressure in an environment close to the actuator known to use it and to avoid circulating very high pressure in ducts external to this structure with all the drawbacks that this entails.

Although the present invention has been described with reference to specific exemplary embodiments, it is obvious that modifications and changes may be made to these examples without departing from the general scope of the invention as defined by the claims. Particularly, individual characteristics of the different illustrated/mentioned embodiments may be combined in additional embodiments. Consequently, the description and the drawings must be considered in an illustrative rather than restrictive sense.

It is also obvious that all the characteristics described with reference to one method are transposable, alone or in combination, to one device, and conversely, all the characteristics described with reference to one device are transposable, alone or in combination, to one method.

1. A pressure adapter comprising:
a first assembly and a second assembly, movable in rotation relative to each other along a main axis,
the first assembly comprising a cam,
the second assembly comprising a cylinder block with a plurality of housings in which pistons slide, each piston being positioned in a housing wherein:
each pair formed by a piston and a housing defines between the piston and the housing a first chamber and a second chamber distinct from each other, the first chamber and the second chamber defining distinct displacements, wherein
the assembly of the first chambers performs a hydraulic motor function, adapted to be connected to a supply providing a first flow rate Q1 at a first pressure P1 and to perform relative rotation of the first assembly and the second assembly,
the assembly of the second chambers performs a hydraulic pump function, adapted to deliver a second flow rate Q2 at a second pressure P2.

2. The pressure adapter according to claim 1, wherein for each pair formed by a piston and a housing, the first chamber defines a displacement strictly greater than the second chamber.

3. The pressure adapter according to claim 1, wherein for each pair formed by a piston and a housing the first chamber defines a displacement strictly smaller than the second chamber.

4. The pressure adapter according to claim 1, wherein for each pair formed by a piston and a housing, the first chamber and the second chamber are superimposed along a sliding direction of the piston in the housing.

5. The pressure adapter according to claim 1, wherein each housing has a first portion with a first section S1, and a second portion with a second section S2, the first section S1 being strictly greater than the second section S2, the first portion extending from an outer surface of the cylinder block, and the second portion extending from the first portion.

6. The pressure adapter according to claim 1, wherein
the assembly of the first chambers performing a hydraulic motor function has a primary intake and a primary discharge,
the assembly of the second chambers performing a hydraulic pump function has a secondary intake and a secondary discharge,
the primary discharge supplies at least part of the secondary intake.

7. The pressure adapter according to claim 6, wherein the connection between the primary discharge and the secondary intake is made via an internal volume of the casing.

8. The pressure adapter according to claim 1, wherein
the assembly of the first chambers performing a hydraulic motor function has a primary intake and a primary discharge,
the assembly of the second chambers performing a hydraulic pump function has a secondary intake and a secondary discharge,
the secondary intake and the primary intake are common.

9. The pressure adapter according to claim 1, wherein:
the first chambers are connected to a first distributor adapted to perform fluid intake and discharge, and
the second chambers are connected to a second distributor adapted to perform fluid intake and discharge.

10. The pressure adapter according to claim 9, wherein
the cylinder block comprises ducts adapted to connect the first chambers to the first distributor, said ducts opening out from the cylinder block at a first distance R1 relative to the main axis, and the cylinder block comprises ducts adapted to connect the second chambers to the second distributor, said ducts opening out from the cylinder block at a second distance R2 relative to the main axis,
the first distance R1 and the second distance R2 being distinct from each other.

11. The pressure adapter according to claim 10, wherein
if Q1>Q2, then R1>R2, and
if Q1<Q2, then R2>R1.

12. The pressure adapter according to claim 1, wherein the pistons and the housings are disposed so as to define a motion of the pistons along a direction parallel to the main axis.

13. The pressure adapter according to claim 1, wherein the pistons and the housings are disposed to define a motion of the pistons along a radial direction relative to the main axis.

14. The pressure adapter according to claim 13, wherein the cam is a multi-lobe cam.

15. The pressure adapter according to claim 13, wherein the first distributor and the second distributor are disposed on either side of the cylinder block along the direction defined by the main axis.

16. The pressure adapter according to claim 15, wherein the first distributor and the second distributor are dimensioned such that the force resulting from the supply of the first chambers and the second chambers respectively by the first distributor and the second distributor tends to move the cylinder block towards one among the first distributor and the second distributor.

17. The pressure adapter according to claim 1, wherein the assembly of the first chambers define a constant velocity motor, and wherein the assembly of the second chambers define a constant velocity pump.
